(19) United States
(12) Patent Application Publication
(10) Pub. No.: US 2004/0039680 A1
(43) Pub. Date: Feb. 26, 2004

(54) Method and device for carrying out an electronic auction in a communications network

(76) Inventors: Markus Horch, Wolfsburg (DE); Meike Hansen, Braunschwaj (DE)

Correspondence Address: KENYON & KENYON, ONE BROADWAY, NEW YORK, NY, 10004, US

(21) Appl. No.: 10/363,606

(22) PCT Filed: Aug. 28, 2001
(86) PCT No.: PCT/EP01/09898

(30) Foreign Application Priority Data
Sep. 4, 2000 (DE) 100 43 860.1

(51) Int. Cl. G06F 17/60

(52) U.S. Cl. 705/37

(57) ABSTRACT

A method is described for carrying out a reverse electronic online auction between a number of bidders and one buyer for the procurement of a product needed by the buyer, over a communications network, having the following steps:

selecting a limited number of bidders based on a specified request for bid by the buyer,

notifying the bidders concerning the point in time, the duration of the auction and the online auction room of the auction,

carrying out the auction at the time period stated, each bidder being able to make his bids during the permissible time period,

each bidder has indicated to him the most favorable bid of the competitors in anonymous form and the remaining auction time, and

calculating a comparison quantity overall costs as a function of the particular price and of further suitable criteria, for comparing the bids of the individual bidders online for each bid, the auction being extended by at least one predetermined time period.

The present invention relates to a method and a device for carrying out an electronic auction in a communications network, according to the definition of the species in claim 1. In particular, the present invention relates to an interactive reverse auction, held over the Internet, and in which a plurality of bidders submit their bids to a buyer with respect to an order having as its content the procurement of required products, such as goods or services.

By an auction is usually understood the sale of an object at which several people meet at one place, usually the auction house, in order to put in their bids for the object to be bought at the auction. In this context, the objects to be auctioned are presented one after another to interested parties, and the highest bid for an object receives the fall of the hammer, that is, the interested party making the highest bid becomes the buyer of the object that was just before to be bought by auction. In spite of the issuance of catalogs of objects to be auctioned off, with the aid of which the interested party may select objects of interest to him, such auctions have the disadvantage that the bidder has to be physically present at the place of the auction, and must have enough time, since the exact point in time of the auction of a certain object is generally not known.

Besides the auction method described above, there are additional types of auctions adapted to the merchandise or rendering of services to be sold. For example, at a closed auction each bidder submits his bid without knowing the bids of the other bidders, the highest bid receiving the acceptance. In the case of a so-called Vickrey auction, in which likewise a closed auction may be involved, the object is sold to the highest bidder at the price of the second highest bid submitted, provided that this price charged is higher than, or equal to a preset minimum price. Another important auction method is the English auction, in which the auction opens at a preset minimum price, and only bids above the minimum price are considered, and the highest bid is accepted. Furthermore, at a Dutch auction, the auction is opened at a high offering price for the respectively offered object, which is progressively lowered until one bidder agrees to the current price.

The auctions in which prices increase, based on the demand by the bidders, are called increasing auctions. In contrast to this is the decreasing or reverse auction, in which the price goes down as a result of the interest on the part of the bidders.

In order to overcome the disadvantages of the physical presence of the bidders and the suppliers at the classical form of auctions, auction methods have been suggested and are used which are held over the Internet. Thus, e-commerce, i.e. the purchase of goods over the Internet, offers, especially to industrial buyers, the possibility of procuring needed products, and is meanwhile being used in the purchasing done by large enterprises. In this context, e-commerce is defined as being the possibility of transacting operational procedures. One possibility of (conducting) e-commerce is the so-called B2B transactions (B2B=business to business), in which the procurement of goods and services made by the contractor is also denoted as e-procurement.

In this vein, a system and method are known from EP-0 987 644, for conducting an electronic auction via a communications network. In this instance, the system includes several bidding devices which are connected to one or several auctioneer devices, it being possible to apply various auctioning methods.

On the Internet there are some suppliers who are also denoted as being Internet auction houses, and who have specialized in auctions in the field of B2B. At this point, we name as examples the enterprises, “eBreviate”, who may be found at “www.ebreviate.com”, “Portum”, whose address is “www.portum.com”, and “Ariba” having the address “www.ariba.com”. These enterprises assume, for a contractor, the execution of auctions, particularly reverse auctions. The carrying out and the advantages by such firms of a reverse auction are described, for example, in articles and examples presented on the home pages of the enterprises named.

Thus, for instance, an article, called a case study, describes the principle of an electronic reverse auction on the home page of Portum. Say, that the purchasing department of an enterprise requires a certain number of pieces of a product at a stated delivery date. The purchasing department defines such items as the quantity required, the product and, if necessary, other boundary conditions in the form of a request for bid or software specifications, and addresses this to the Internet auctioneer. The latter makes available an online auction room at a certain point in time and notifies potential suppliers, while including the request for bid or the software specifications. Furthermore, the maximum price of the product is determined by the purchaser. The vendors interested in the auction are instructed by the Internet auctioneer. Subsequently, at the time announced, the auction takes place with the interested suppliers, the auction being limited to a predefined time period. Only during this time period can the suppliers make bids over the Internet for the order on which bids were invited. In this context, one bidder sees the bids of the other bidders anonymously, generally only the best anonymous bid being displayed. At any time during the auction period, the bidder may underbid this best bid. After the expiration of the auction time period, the purchasing department issues an acceptance of the bid to a bidder who may not have been the most favorable one, unless this was explicitly stipulated in the rules of the auction.

In many cases price will be the decisive criterion for acceptance of the bid, however, the supplier who is pricewise most favorable is not always also the best, since there are additional features which may play an important role, such as quality and grade of the merchandise, production capacity of the supplier in the case of large volume orders, adequate delivery possibilities at certain time markers, etc. Thus, the most favorable price may not be decisive for placing an order, if the supplier offering this price cannot deliver at the required delivery date because of other delivery commitments, but only at a later time.

In order to solve this problem, that is, to find the most suitable supplier, in the reverse auction system of “eBreviate” a so-called overall cost function is introduced which evaluates the other factors mentioned and sets a fictitious overall price from the bid and the evaluated boundary conditions, in order to make possible a more realistic comparison between the bids.

In a great number of fields in industry, reverse auctions on the Internet are already being used for the faster and more cost-effective procurement of needed parts and articles. It is true, however, that the auction formats used do not yet deliver optimum results for the buyer with respect to bidder behavior and choice of the most suitable bidder for a needed product.

Therefore, the present invention is based on the object of creating an improved auction method, in particular a reverse auction method, and a corresponding auction device.

The object is attained by a method according to claim 1 as well as claim 5, and a device according to claim 14.

Advantageous embodiments and further refinements of the present invention are the subject matter' of the dependent claims.

A first method, according to the present invention, for carrying out an electronic online auction between a number of bidders and one buyer for the procurement of needed goods or services of the buyer over a communications network has the following steps:

selecting a number of bidders who are able to make available the needed goods or services,

notifying the bidders concerning the point in time, the permissible time period of the auction provided and the online auction room of the auction,

conducting the auction at the time announced, each bidder being able to submit his bids during the permissible time period, which is formed by the predefined first time duration; each bidder has indicated to him at least the lowest bid of the competitors in anonymous form and the remaining auction time, and, for the comparison of the bids of the individual bidders, online, for each bid, a comparison quantity overall costs is calculated as a function of the particular price and further suitable criteria, the permissible time duration of the auction being prolonged by an extension interval before its expiration, so that a new permissible time duration is established.

Preferably, a remaining time interval is specified, the bidders being notified of this remaining time interval only when the remaining auction time is less than, or equal to the remaining time interval. An extension of the auction is preferably carried out in the remaining time interval, the duration of the extension interval(s) for each extension being able to be selected.

A second method, according to the present invention, for carrying out an electronic auction between a number of bidders and one buyer for the procurement of needed goods or services of the buyer over a communications network, which also includes the possibility of the extension of a permissible auction duration, has the following steps:

selecting a limited number of bidders based on a specified request for bid by the buyer,

notifying the bidders concerning the point in time of the auction, the permissible time period of the auction and the online auction room of the auction,

conducting the auction at the time announced, each bidder being able to submit his bids during the permissible time; each bidder has indicated to him at least the lowest bid of the competitors in anonymous form and the remaining auction time, and, for the comparison of the bids of the individual bidders online for each bid, a comparison quantity overall costs is calculated as a function of the particular price and further suitable criteria; each bid including a specified number of price quantities which are essential quantities for the buyer's decision-making, and the overall costs (total turnover) being determined from the individual cost quantities of a bid according to a predefined algorithm for each bid, the overall costs for each bidder being calculated online exactly to the day, with the aid of his current bid for the designated delivery period.

Furthermore, a device according to the present invention for carrying out one of the above methods has a server for carrying out the auction, bidder stations connected to the server via a communications network and a device for the online ascertainment of the particular overall costs of a bid.

Preferred specific embodiments of the present invention are explained below in greater detail in light of the drawings.

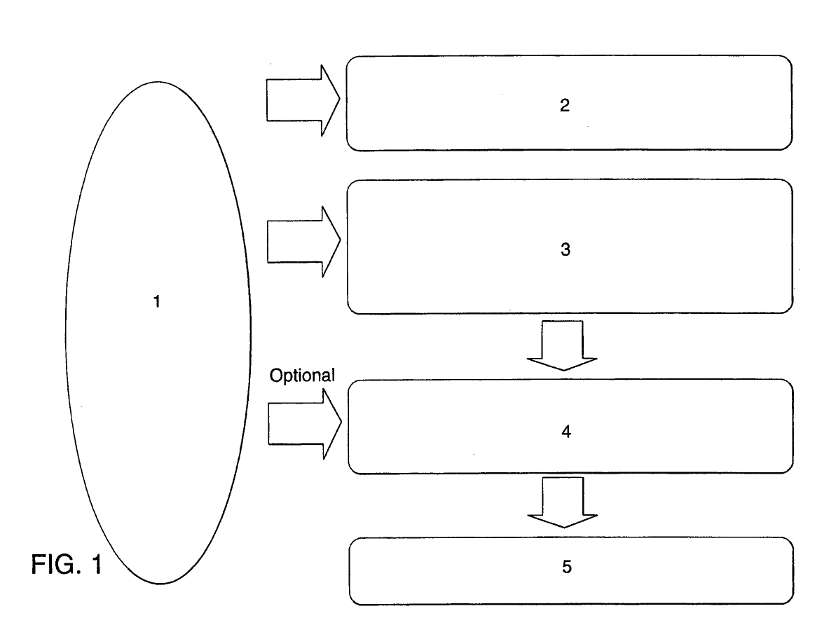

FIG. 1 shows in a schematic illustration the procurement of necessary material by the purchasing department of a buyer,

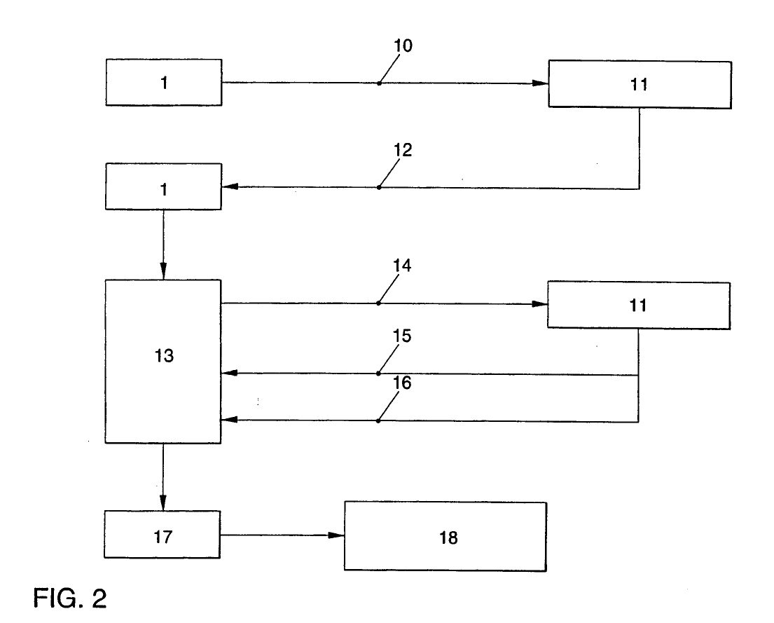

FIG. 2 shows in a schematic illustration the sequence of an online auction,

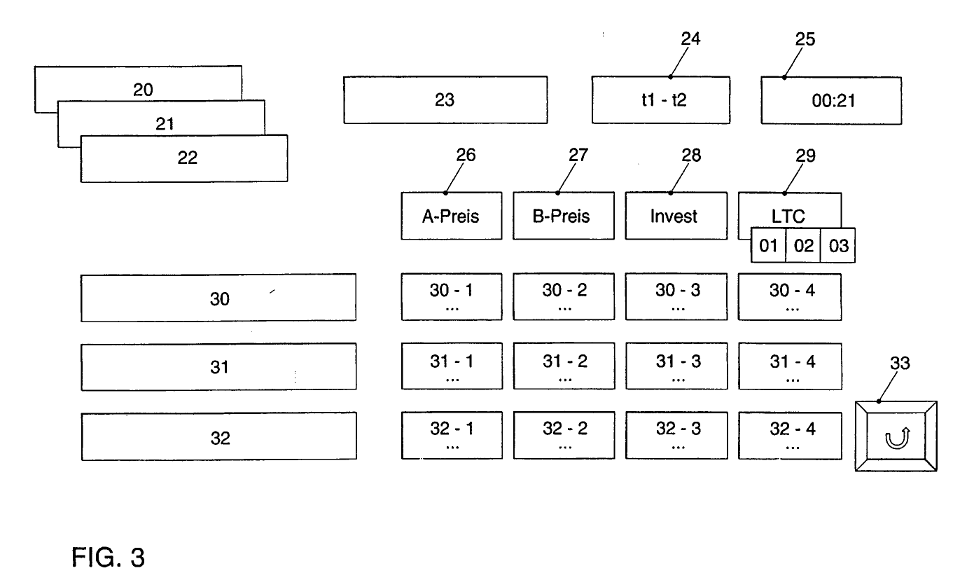

FIG. 3 shows a possible auction superficies of the buyer, and

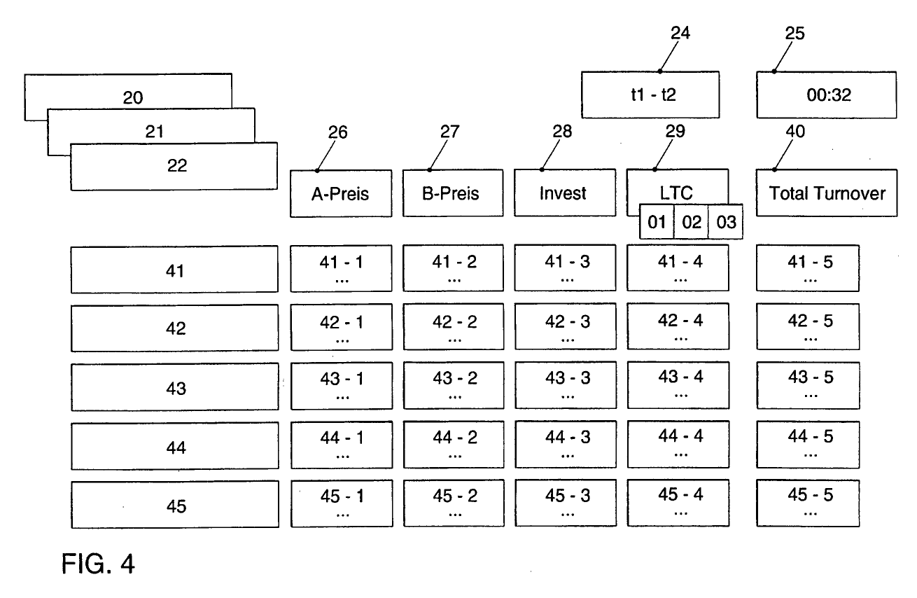

FIG. 4 shows a possible auction superficies of the bidders.

FIG. 1 shows the possibilities of a procurement process by purchasing department 1 of a buyer, purchasing department 1 controlling the procurement. In the case of products or goods which are not suitable for purchase by online auction, the usual procurement process 2 is carried out, using request for bid and evaluation of the written bids from suppliers, as well as oral negotiations, if necessary. Here too, there is the possibility of electronic contacting and negotiation, so-called e-sourcing.

In the case of products or services which are suitable for procurement by online auction, purchasing department 1 checks in a preliminary decision 3, with the aid of, for instance, a request for bids sent to possible suppliers, and the resulting returns, whether the product offered and the supplier meet the requirements of the buyer. As a result of bidders' group decision 3, the group of possible suppliers yields the final group of bidders for the online auction. Within bidders' group decision 3, the selected bidders are instructed with respect to the location, i.e. the online auction room, the time and the duration of the auction. In addition, a training session may be carried out for the bidders before the actual auction, in order to make certain that the bidders are familiar with superficies of the auction. The bidders selected in bidders group decision 3 take part in online auction 4, and the result of this auction yields a preliminary decision on the awarding of the order with respect to delivery of the auctioned product. In the case of this online auction 4, an online renegotiation may also be involved, for example, if it turns out, during the auction that has been carried out, that a subset of the originally selected bidders come into consideration as suppliers. Then a bidders' group decision 3 no longer has to be carried out, and the online renegotiation, which is likewise carried out in the form of an online auction, is directly initiated by purchasing department 1. The result of online auction 4 or the online renegotiation is an award proposal 5, using which the final decision is then made.

FIG. 2 shows a detailed representation of the execution of the online auction shown in FIG. 1. The purchasing department 1 of a buyer has the task of procuring needed products, i.e. goods or services, within the framework of B2B transactions, and sends a request for bid 10 to potential suppliers 11. Request for bid 10 includes, for example, the technical specifications of the product to be procured, the quantity to be delivered or the delivery volume, specifications of the tooling to be used for producing the product, delivery dates, delivery conditions and packaging, etc. In addition, the request for bid includes a list or the number of various cost variables, such as price at supplier, price including delivery to a specified location, tooling costs, long-range discounts, etc., for which the possible supplier has to submit a bid. Each interested supplier 11 submits a first bid to purchasing department 1, within a specified period. Furthermore, the bid of the potential supplier must include statements concerning the additional specifications addressed in the request for bid, that is, such as whether the supplier is able to deliver the desired delivery quantity in the first place or only a part, whether the requisite quality can be maintained, whether specified delivery dates are possible, etc. From the bids received, purchasing department 1 makes a choice among the suppliers, those suppliers which were selected for participation in the online auction being designated as bidders. At the beginning of auction 4 at the specified point in time, virtual auction room 13, in other words the virtual auctioneer, transmits the best bid in anonymous form to bidders 11, the best bid being composed of the most favorable individual cost variables of the bids of all bidders 11. For example, a bidder may bid the most favorable price per piece ex factory, which is designated as an A-price, while another bidder bids a more favorable piece price including delivery, which is designated as B-price. Yet another bidder has the most favorable tooling costs. Thus, each bidder sees only the most favorable individual cost quantities during auction 4. During the auction, the bidders make further bids 14 to electronic auctioneer 13. Upon expiration of specified auction time 15, which in each case may be prolonged by time intervals having selectable length, the auction is closed, and no further bids are accepted. A preliminary decision 16 is made, whose result, for example, is fed back to an appropriate panel for decision and placement of the order 17.

FIG. 3 shows an example of an auction superficies, the way it is transmitted to a bidder during the online auction from the online auction room. The superficies, or rather the form includes a part description 20 and the part number 21 of the auctioned product, the descriptions and the numbers of the buyer being involved in this regard, and the volume 22 of the order is given. In addition, supplier name 23, auction time 24 as well as the remaining auction duration 25 is given on the auction superficies of each bidder. In this example of an auction, bids for four cost quantities are given, namely A-price 26, that is the price of a product at the supplier, B-price 27, that is the price of a product including delivery to a location selected by the buyer, investment 28 (invest), that is, the other costs, such as, for example, tooling costs which are to be taken on by the buyer, as well as long term conditions 29 (LTC). Regarding the long term conditions, an additional difference is made between the ones for a first time period 29-01, a second time period 29-02 and a third time period 29-03. Instead of first to third time period, the first to third delivery or the like may also be involved. The bidder sees his own currently valid bid 30 for cost quantities A-price 26, B-price 27, invest 28 and LTC 29 in the corresponding display fields 30-1 to 30-4. At the beginning of the auction, the starting bid is shown in fields 30-1 to 30-4 under current bid 30. Currently best bid 31 is shown under currently valid bid 30, in display fields 31-1 to 31-4. In this context, the four best cost quantities shown are composed of the bids selected from the most favored cost quantities from the bids of all bids taken together. The possibility of a new bid 32 is arranged among them, so that the bidder may make a new bid in display fields 32-1 to 32-4 for the four cost quantities used here as an example, which is dispatched and made valid by operating return key 33.

FIG. 4 shows an auction superficies as shown to the buyer and the auctioneer. In this case, the auction superficies partially includes the identical information as the bidder superficies, namely part description 20 of the product auctioned, corresponding part number 21 and auctioned volume 22, which is given, for instance, as volume/year. Furthermore, auction time 24 and remaining auction duration 25 are shown. In a suitable display matrix, A-price 26, B-price 27, investment 28, long term conditions LTC 29 and total turnover 40 are displayed as a function of supplier A-41, supplier B-42, supplier C-43, supplier D-44 and supplier E-45 in the form of corresponding display fields 41-1 to 41-5, 42-1 to 42-5, 43-1 to 43-5, 44-1 to 44-5 and 45-1 to 45-5. The computation of total turnover 40 for each bid, particularly each new bid of a bidder, is made online with, or rather upon receipt of a bid, and is displayed directly after the computation, so that the buyer's purchasing department is immediately able to gain for itself an idea of the current state of the auction and the capability of the bidders, with the aid of the auction superficies “buyer”. Furthermore, it is possible, for example, to back in color the most favorable components or cost quantities of the bids of all bidders, to achieve an optical highlighting in the auction superficies of the buyer, or to show it separately.

The auction superficies shown in FIGS. 3 and 4 are intended only as examples. For the purpose of making a judgment with respect to the bidders and their bids, additional cost factors or parameters may be checked with the bidders, who have to mention them in their bids. Furthermore, from the possible parameters, other cost quantities may be defined, such as savings compared to previous deliveries, etc.

The calculation of these overall costs, or the “total turnover” are shown below, as well as the important cost quantities and cost factors important for the judgment of a bidder's bid.

A Calculation of Amortization

The cost quantity amortization “AMORT”, which may be used for decision making, and which may be shown on the buyer's side of the auction superficies, is calculated according to the following formula, the amortization expressed in months being involved in this case, that is, as the result, the number of months is given within which an investment “INVEST” is amortized.

AMORT=12·INVEST/(A_PRICE_A-A_PRICE_N)·DEMAND

where

A_PRICE_A is the old A-price, i.e. the price at the supplier, which will be specified more exactly below,

A_PRICE_N is the new A-price, which is derived from the current bid of a bidder,

A_PRICE_C is the current A-price at which delivery is made, and

DEMAND represents the annual demand of the required product.

Three different cases are used for determining which old A-price A_PRICE_A is used to calculate amortization, namely,

1. Among the bidders there is a current supplier:

For this current supplier, the old A-price is determined as follows:

A_PRICE_A (current supplier)=A_PRICE_C (current supplier)

For the new bidders, the old A-price is determined from the new A-price of the current supplier:

A_PRICE_A (new bidder)=A_PRICE_N (current supplier)

2. Among the bidders there are several current suppliers.

The minimum of the new A-prices of the bidding suppliers is taken:

A_PRICE_A (all suppliers)=MIN(A_PRICE_N (all current suppliers))

3. There is no current supplier among the bidders. Therefore, the average of the current A-prices of the currently delivering suppliers is used, who, however, do not take part in the auction, i.e. will no longer deliver in the future.

A_PRICE_A (all suppliers)=Ø(A_PRICE_C (all current suppliers))

B Calculation of the Savings

I. General Scheme for the Savings Calculation

1. First, the earliest delivery date of all propspective suppliers, denoted as the introdate' from here on, is ascertained.

2. The year's turnover, turnover_year is calculated for the previous year using the price of the present delivery situation.

3. If the earliest introdate is not 01/01 of a years, a partial turnover amount is calculated, likewise still using the price of the present delivery situation.

4. Subsequently, the partial turnover amounts turnover are calculated for each prospective supplier, for all the years of his time of supplying, in the following manner:

Turnover=A_price·demand·number_days/number_days_year·quota/sum_quota

In the case of a discount reduction, a new A-price is formed according to the scheme shown below:

A_price red=A_price−(A_price·reduction/100),

and the new A-price is set equal to the reduced price:

A_price=A_price_red

Using this A_price, the corresponding partial turnover amount is then calculated.

In this context, it is checked, for each section to be looked at, whether the delivery situation has changed, i.e. whether the various other suppliers are completely taking over the delivery. The partial amounts are summed up in the corresponding “year slots”.

1. The last year, that is the year during which the delivery time to be looked at is reached, is then “filled up” to the end of the year using the last delivery situation, so as to obtain correct annual turnovers.

2. After all suppliers have been processed, the absolute and the relative savings for the year n are calculated as a function of annual turnover of the previous and the current years, as follows:

saving_absolute_year(n)=turnover_year(n−1)−turnover_year(n)

saving_percent_year(n)=turnover year(n−1)−turnover_year(n)/ABS(turnover_year(n−1))·100,

where the function ABS is understood here to be the amount.

II. Variant of the Savings Calculation

1. Determination of the lowest introdate of all suppliers.

2. Determination of the last introdate of all suppliers.

3. Determination of the end of the savings calculation: last delivery situation +1 year.

4. For the year before the lowest introdate (see point 1), the annual turnover is calculated using the price of the current situation. The value is stored in the corresponding year slot.

5. If the minimum introdate (see point 1) is not on 01/01 of a year, the turnover share for the months up to this date is likewise still calculated using the price of the current situation and stored in the corresponding year slot.

6. For each supplier, there now begins a cycle in which, beginning with the earliest introdate, all turnover share corresponding to the introdate stages and discounts are calculated and stored in each respective year slot. The discounts are taken into consideration using the savings beginning subsequently to the date of application. A discount always refers to the last price of the supplier.

It should be noted that the discounts are taken into consideration only if, at the time of the application, the sum of the quotas of the other suppliers <80%, that is:

If, before or after the application date of the subsequent savings, the delivery situation of the other suppliers has changed in such a way that the other suppliers together have a quota of 80% or (even) 100%, then in this new delivery situation the delivery time ends for the supplier under consideration.

If there is more than a year between the last introdate and the application date of the subsequent savings, the turnover shares for this entire time period are calculated using the most recent valid price. Thus, the principle of the validity of a price for only one year has no application here, since in each case total annual turnovers are to be compared to one another.

7. If in the cycle the date arrives which agrees with the most recent introdate (see point 2) and if the supplier has a quota, then beginning at this date and to the end of the savings calculation (see point 3) calculating is continued and the turnover shares are stored in the corresponding year slots.

The calculation is also continued to the end of the savings calculation (see point 3) if a discount reduction still exists.

If this last turnover disk does not end on 12/31 of the corresponding year, the last price is used to supplement up to year's end, so that one can compare the total year's turnover to the one of the year before.

If a supplier has no quota and/or no discount for the last introdate (see point 2), the end of the delivery time for this supplier has thereby been reached, and no further calculation is made. The last turnover disk for such a supplier thus ends at this date, no matter whether the time expired since the previous date is a year or less.

8. At the end of the computing cycles for the suppliers, a summary is made for each year of old turnover shares lying in the corresponding slots.

The absolute values of the savings are then calculated using the formulas given in I. 6.

C Calculation of Turnover Exactly to the Day

The calculation of turnover is done here exactly to the day. More accurately speaking, the calculation is made for the time period between the day following the current day and the end of the running time for all suppliers. The earliest delivery date earliest introdate, stepwise delivery dates stepwise introdates and application date subsequent savings are taken into consideration.

An auxiliary variable, possible introdate, indicates on which date new suppliers for whom quotas have not yet been fixed can begin delivering.

The possible introdate is used and applied in the following cases:

1. Only the current suppliers exist, but they have no quota.

2. Current and new suppliers exist, but none of the suppliers has a quota.

3. The current suppliers continue to deliver, there is a quota. However, there are also new suppliers, of whom none has a quota or an earliest introdate.

The following arrangement is made as to the calculating time period:

The running time begins on the day following the current date.

The end of the running time is either the maximum date of use of subsequent savings of all bidders Plus 1 year, when at least one bidder has discounts, or the maximum introdate of all bidders plus one year if no bidder has discounts.

For the turnover calculation, the following arrangement is made for the introdate:

If an earliest introdate is present, then it is used.

If no earliest introdate is present, the minimum earliest introdate of all the remaining suppliers, who are not current suppliers, is used. If these do not exist, the possible introdate is used.

The application date subsequent savings is determined as follows (taken into consideration only if discounts reductions are present):

If an application date subsequent savings exists, this is used.

If no application date subsequent savings is present, either the application date subsequent savings of the supplier having discounts is used who is not a current supplier and who has the highest quota of all new suppliers having discounts, or,

if an application date subsequent savings cannot be determined, the possible introdate is put to use. The application date subsequent savings is fixed to be 01/01 of the year following the possible introdate, or

if this is also not possible, the application date subsequent savings is fixed to be 01/01 of the year following the current data.

A consideration of introdate steps takes place only when the base set has a quota. Thus, if graduated prices are also present, the turnover proportions are calculated to the exact day for the corresponding sections.

The fact that discounts reductions apply only to the A-price and not to the B-price is expressed by the following formulas:

extra charge=B_price−A-price;

A_price(new)=A_price(old)−(A_price(old)·reduction/100);

B_price(new)=A_price(new)+surcharge;

An example for this is given below:

| | |
|---|---|
| A_price = | 10.00 EURO |
| B-price = | 12.00 EURO |
| red_1 = | 2% |
| red_2 = | 1% |
| Surcharge = | B_price − A_price; |
| A_price(1) = | A_price − (A_price·red_1/100); |
| B_price(1) = | A_price(1) + surcharge; |
| A_price(2) = | A_price(1) − (A_price(1)·red_2/100); |
| B_price(2) = | A_price(2) + surcharge; |

It is also true that:

| | | |
|---|---|---|
| surcharge = | B_price − A_price = | 2.00; |
| A_price(1) = | 10.00 − 0.20 = | 9.80; |
| B_price(1) = | 9.80 + 2.00 = | 11.80; |
| A_price(2) = | 9.80 − 0.098 ∓ | 9.70; |
| B_price(2) = | 9.70 + 2.00 ∓ | 11.70; |

Thus, the turnover calculation is made with the B_prices according to the following scheme:

The turnover is calculated for each supplier for the entire running time to the exact day. If there is a leap day in a section of a year, it is deducted.

$$\begin{matrix}turnover = ( B\_price ( curr ) \cdot numb\_days ( curr ) / 365 + \\ B\_price ( 1 ) \cdot numb\_days ( 1 ) / 365 + \\ B\_price ( 2 ) \cdot numb\_days ( 2 ) / 365 + … + \\ B\_price ( n ) \cdot numb\_days ( n ) / 365 ) \cdot requirements + invest ;\end{matrix}$$

where B_price(curr) is the current B_price, discounts for 1 to n time periods were assumed (B_price(1) to B_price(n)), requirements the number of products required in the entire time period and invest the tooling costs raised.

Reference Symbol List

1 purchasing department

2 classical procurement procedure

3 bidders group decision

4 online auction, online renegotiation

5 contract awarding decision

10 request for bid

11 suppliers

12 first bid

13 auction room or auctioneer

14 best bid

15 bid via internet during the auction

16 lapse of time

17 preliminary decision

18 final decision

20 part identification

21 part number

22 volume (e.g. per annum)

23 name of bidding supplier

24 auction time

25 remaining auction duration

26 A-price

27 B-price

28 investment

29 long term conditions

30 presently valid bid

30-1-30-4 indicator fields

31 currently best bid, including the best cost variables at the time

31-1-31-4 indicator fields

32 new bid

32-1-32-4 indicator fields

33 confirmation key

40 total turnover

41 supplier A

41-1-41-5 indicator fields

42 supplier B

42-1-42-5 indicator fields

43 supplier C

41-1-41-5 indicator fields

44 supplier D

44-1-44-5 indicator fields

45 supplier E

45-1-45-5 indicator fields

What is claimed is:

1. A method for carrying out an electronic online auction between a number of bidders and one buyer for the procurement of a product needed by the buyer over a communications network having the following steps:
selecting a number of bidders who are able to make the product available,
notifying the bidders concerning the time, the permissible time period of the auction provided and the online auction room of the auction,
carrying out the auction at the specified point in time, each bidder being able to make his bids during the permissible time period which is formed by the specified first time duration, each bidder having indicated to him at least the lowest bid of the competitors in an anonymous form and the remaining auction time, and for comparison of the bids of the individual bidders, online, for each bid, a comparison quantity overall costs is calculated as a function of the particular price and of further suitable criteria,
wherein the permissible time duration of the auction is extended before its expiration by an extension interval, so that a new permissible time duration comes about.

2. The method as recited in claim 1, wherein a remaining time interval is defined, and only this remaining time interval is notified to the bidders when the remaining auction time is less than, or equal to the remaining time interval.

3. The method as recited in claim 2, wherein the extension of the auction is carried out in the remaining time interval.

4. The method as recited in one of the preceding claims, wherein the duration of the extension interval is selectable for each extension.

5. A method, particularly as recited in one of the preceding claims, for carrying out an electronic auction having a number of bidders and one buyer for the procurement of a product needed by the buyer over a communications network having the following steps:
selecting a limited number of bidders based on a specified request for bid by the buyer,
notifying the bidders concerning the point in time, the permissible time period of the auction and the online auction room of the auction,
carrying out the auction at the specified time period, each bidder being able to make his bids during the permissible time period, each bidder having indicated to him at least the most favorable bid of the competitors in an anonymous form and the remaining auction time, and for comparison of the bids of the individual bidders, online, for each bid, a comparison variable overall costs is calculated as a function of the particular price and of further suitable criteria,
wherein each bid includes a specified number of various cost variables, each cost variable being an essential quantity for the buyer's decision making, and the overall turnover as well as further cost functions are ascertained for each bid from the stated cost variables of a bid according to a predefined algorithm, the overall turnover for each bidder being calculated online to the exact day, using his current bid for the delivery time period provided.

6. The method as recited in claim 5, wherein besides the parameter A-price, i.e. the price at the supplier, the bid of a bidder also includes at least one B-price, i.e. the price including delivery to a specified location, the possible delivery volume, the necessary investment on the part of the buyer, i.e., for example, tooling costs, and the long term conditions for a delivery in specified consecutive time periods.

7. The method as recited in claim 5 or 6, wherein the lowest bid, which is sent to each bidder in anonymous form, is composed of the most favorable cost quantities of all the bids made.

8. The method as recited in one of claims 5-7, wherein the savings are calculated for each bidder for the delivery time period provided, using the cost variables stated, the overall turnover of the preceding delivery period being used for the calculation.

9. The method as recited in one of claims 5-8, wherein the cost functions calculated online from the cost quantities are indicated to the buyer.

10. The method according to one of the preceding claims, wherein for admission to the auction, each bidder has to satisfy a set of quality requirements which is a component of the request for bid.

11. The method according to one of the preceding claims, wherein after the end of the auction, a subset of the bidders is selected with the aid of the calculated cost functions, using which, renegotiations are held in the form of a further online auction.

12. The method according to one of the preceding claims, wherein each selected bidder obtains access to the online auction by using an individual key.

13. The method according to one of the preceding claims, wherein a reverse auction is carried out.

14. A device for carrying out the method as recited in one of the preceding claims, having a server, for carrying out the auction, bidder stations connected to the server over a communications network and a device for ascertaining online the particular cost functions of a bid.

15. The device as recited in claim 14, wherein the communications network is formed by the Internet.

16. The device as recited in one of claim 14 or 15, wherein the communications between the server and the bidder stations take place in coded form.

17. The device as recited in one of claims 14-16, wherein each bidder station has an indicator device and an input device, a bidder form for inputting a bid being shown on the indicator device, and a bidder form includes information concerning the last valid bid of the bidder, the most favorable current bid of the other bidders in anonymous form, the remaining duration of the auction and the subject matter of the auction, and input fields for inputting a new bid are provided.

18. A computer program having program code means for carrying out all the steps of the method according to one of claims 1-13, when the program is run on a computer.

19. The computer program having program code means according to claim 18, which are stored on a computer-readable data carrier.
